(19) United States
(12) Patent Application Publication
(10) Pub. No.: US 2006/0268127 A1
(43) Pub. Date: Nov. 30, 2006

(54) Image pickup apparatus

(75) Inventors: Kazuchika Sato, Kobe-shi (JP); Masataka Hamada, Osakasayama-shi (JP); Yasuaki Serita, Sakai-shi (JP); Tsuyoshi Iwamoto, Nishinomiya-shi (JP); Koichi Kamon, Sakai-shi (JP); Tomokazu Kakumoto, Yokohama-shi (JP)

Correspondence Address: SIDLEY AUSTIN LLP, 717 NORTH HARWOOD, SUITE 3400, DALLAS, TX, 75201, US

(73) Assignee: KONICA MINOLTA HOLDINGS, INC.

(21) Appl. No.: 11/440,392

(22) Filed: May 24, 2006

(30) Foreign Application Priority Data
May 31, 2005 (JP) 2005-158931

(51) Int. Cl. H04N 5/76

(52) U.S. Cl. 348/231.99

(57) ABSTRACT

When picking up an image using an image pickup device having a photoelectric conversion characteristic composed of a linear characteristic region and a logarithmic characteristic region, regardless of an image pickup mode and a recording mode, an image pickup apparatus always obtaining optimum images will be provided. An image pickup apparatus for recording any of an unprocessed image, an image subject to a predetermined image process and image compression, and an image subject to the predetermined image process, a wide dynamic range image processing, and image compression in accordance with the image pickup mode and recording mode, thereby always obtaining optimum images will be provided.

This application is based on Japanese Patent Application No. 2005-158931 filed on May 31, 2005, in Japanese Patent Office, the entire content of which is hereby incorporated by reference.

### TECHNICAL FIELD

The present invention relates to an image pickup apparatus and more particularly to an image pickup apparatus having two image pickup modes of normal image pickup mode and wide dynamic range image pickup mode and two recording formats of unprocessed image recording format and processed image recording format.

### BACKGROUND

Conventionally, a logarithmic conversion type image pickup device in which a logarithmic conversion circuit having a MOSFET is added to a solid-state image pickup device composed of photoelectric conversion devices such as photodiodes arranged in a matrix shape is known, the logarithmic conversion type image pickup device in which the sub-threshold characteristic of the MOSFET is used, thus an electric signal is logarithmically converted for an amount of incident light by the output characteristic of the solid-state image pickup (for example, refer to Patent Document 1).

Further, a logarithmic conversion type image pickup device in which a specific reset voltage is given to the MOSFET, thus the intrinsic output characteristic of the solid-state image pickup device, that is, a linear characteristic state that an electric signal is linearly converted and outputted according to the amount of incident light and the logarithmic characteristic state aforementioned can be switched automatically is known (for example, refer to Patent Document 2). Furthermore, an image pickup apparatus in which the linear characteristic state can be automatically switched to the logarithmic characteristic state, and the reset time of the MOSFET is adjusted, thus the potential state of the MOSFET can be adjusted is disclosed (for example, refer to Patent Document 3).

On the other hand, a digital camera, which is a typical example of the image pickup apparatus, regarding recording of picked-up images, having a mode for recording processed images (images subject to the image processing) and a mode for recording unprocessed images (images not subject to the image processing) is known (for example, refer to Non-Patent Document 1). Processed images include, for example, images of JPEG, bit map, and TIFF and unprocessed images include RAW images.

Patent Document 1: Japanese Laid-Open Patent Application HEI11-298798

Patent Document 2: Japanese Laid-Open Patent Application 2002-77733

Patent Document 3: Japanese Laid-Open Patent Application 2002-300476

Non-Patent Document 1: α-7DIGITAL Catalog, Konica Minolta Photo-Imaging Co., Ltd.

(http://konicaminolta.jp/products/consumer/digital_came ra/catalogue/pdf/a-7digital.pdf) page 9/9, Column of “Recording Format” of “Recording Section”, Retrieved on May 10, 2005

However, when the image pickup devices disclosed in Patent Documents 1 to 3 are used in the linear characteristic state, output in proportion to the electric charge generated in the photoelectric conversion device is obtained, so that there is an advantage that even a photographic subject at low brightness can obtain an image signal having a high contrast (a high gradation), while there is a disadvantage that the dynamic range is narrow. On the other hand, when the image pickup devices disclosed in Patent Documents 1 to 3 are used in the logarithmic characteristic state, output converted natural-logarithmically for the amount of incident light is obtained, so that there is an advantage that a wide dynamic range can be ensured, while an image signal is compressed logarithmically, so that there is a disadvantage that the contrast is low.

Further, when the image pickup devices disclosed in Patent Documents 1 to 3 are used in the state of coexistence of the linear characteristic state and logarithmic characteristic state, the wide dynamic range can be ensured, though there is a disadvantage that the contrast of the part in the logarithmic characteristic state is low.

Furthermore, depending on recording of those images as processed images or recording thereof as unprocessed images, the contents of image processing differ greatly.

### SUMMARY

The present invention was developed in view of the foregoing and is intended to provide an image pickup apparatus, when picking up an image using an image pickup device having a photoelectric conversion characteristic composed of a linear characteristic region and a logarithmic characteristic region, for performing an appropriate image process according to the image pickup mode and recording mode, thereby always obtaining optimum images. In view of forgoing, one embodiment of an image pickup apparatus according to one aspect of the present invention is an image pickup apparatus, comprising:

an image pickup device which takes an image of a photographic subject and outputs an electric signal corresponding to the image, the image pickup device being capable of operating a normal image pickup mode and a wide dynamic range image pickup mode with a wider dynamic range than the normal image pickup mode;

an image processing section which processes the electric signal outputted from the image pickup device, the image processing section being capable of a normal image processing as a versatile image processing and a wide dynamic range image processing as an image processing specific for images picked up in the wide dynamic range image pickup mode;

an image recording section which includes an image recording media, the image recording section for recording an image signal processed by the image processing section in the image recording media;

an recording format selection section for selecting one mode from an unprocessed image recording format and a processed image recording format as a recording format in the image recording section;

an image pickup mode selection section for selecting one mode from the normal image pickup mode or the wide dynamic range image pickup mode; and

an image pickup control section which controls a process executed in the image processing section based on the image pickup mode selected by the mode selection section and the recording format selected by the recording format selection section.

According to another aspect of the present invention, another embodiment of an image pickup apparatus is an image pickup apparatus, comprising:

an image pickup device which takes an image of a photographic subject and outputs an electric signal corresponding to the image, the image pickup device being capable of operating a normal image pickup mode and a wide dynamic range image pickup mode with a wider dynamic range than the normal image pickup mode;

an image processing section which processes the electric signal outputted from the image pickup device, the image processing section being capable of a normal image processing as a versatile image processing and a wide dynamic range image processing as an image processing specific for images picked up in the wide dynamic range image pickup mode;

an image recording section which includes an image recording media, the image recording section for recording an image signal processed by the image processing section in the image recording media;

an recording format selection section for selecting one mode from an unprocessed image recording format and a processed image recording format as a recording format in the image recording section;

an image pickup mode selection section for selecting one mode from the normal image pickup mode or the wide dynamic range image pickup mode; and

an image pickup control section which controls a process executed in the image processing section based on the image pickup mode selected by the mode selection section and the recording format selected by the recording format selection section,

wherein the image pickup control section makes the image processing section execute the normal image processing when the image pickup mode selection section selects the normal image processing mode, and the image recording format selection section selects the processed image recording format, and the image pickup control section makes the image processing section execute the normal image processing and the wide dynamic range image processing when the image pickup mode selection section selects the wide dynamic range image pickup mode, and the recording format selection section selects the processed image recording format.

### BRIEF DESCRIPTION OF THE DRAWINGS

FIG. 1 is an external schematic view of a digital camera which is an example of the image pickup apparatus relating to the embodiment of the present invention.

FIG. 2 is a block diagram showing an example of the circuit of the digital camera shown in FIG. 1.

FIG. 3 is a main routine of the flow chart showing the flow of the image pickup operation of the embodiment of the present invention.

FIG. 4 is a sub-routine (1/4) of the flow chart showing the flow of the image pickup operation of the embodiment of the present invention.

FIG. 5 is a sub-routine (2/4) of the flow chart showing the flow of the image pickup operation of the embodiment of the present invention.

FIG. 6 is a sub-routine (3/4) of the flow chart showing the flow of the image pickup operation of the embodiment of the present invention.

FIG. 7 is a sub-routine (4/4) of the flow chart showing the flow of the image pickup operation of the embodiment of the present invention.

FIG. 8 is a block diagram showing an example of the internal constitution of an image pickup device used in the image pickup apparatus relating to the embodiment of the present invention.

FIG. 9 is a circuit diagram showing an example of the circuit of pixels having a photoelectric conversion characteristic composed of a linear characteristic region and a logarithmic characteristic region composing the image pickup device.

FIG. 10 is a graph showing the photoelectric conversion characteristic of the pixel circuit shown in FIG. 9.

FIG. 11 is a circuit block diagram showing an example of the circuit constitution of the image processing section.

FIG. 12 is a graph of the photoelectric conversion characteristic showing the process by the white balance processing unit.

FIG. 13 is a function block diagram for explaining the function of the heightening contrast processing section.

FIG. 14 is a graph showing the photoelectric conversion characteristic of an input image of the region divided part.

FIG. 15 is a graph showing the photoelectric conversion characteristic of an output image of the image composite part.

FIG. 16 is a circuit block diagram showing an example of the circuit constitution of the image processing section of a form using no switching unit.

FIG. 17 is a graph showing changes in the image output due to resetting of the parameter of the heightening contrast processing section.

### DETAILED DESCRIPTION OF THE PREFERRED EMBODIMENT

Hereinafter, the embodiment of the present invention will be explained with reference to the accompanying drawings.

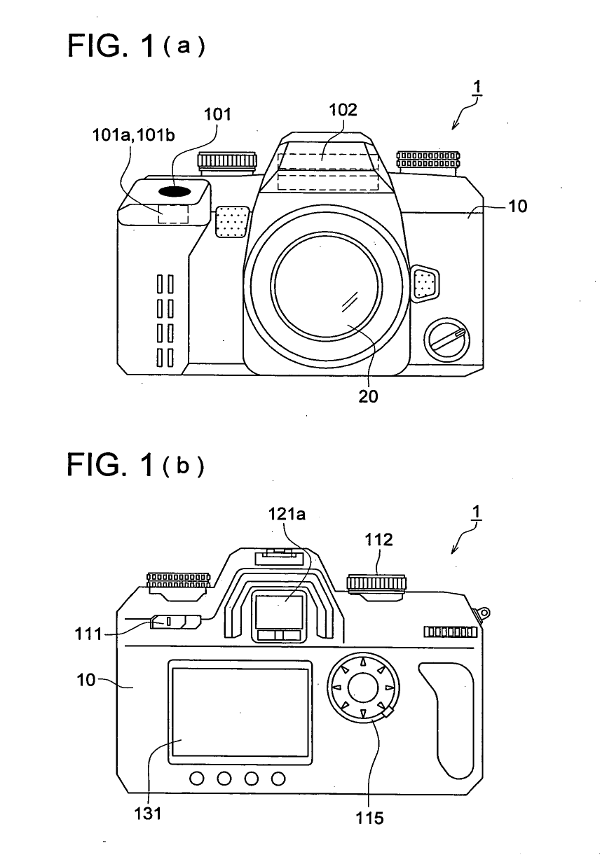

FIG. 1 is an external schematic view of a digital camera 1 which is an example of the image pickup apparatus relating to the embodiment of the present invention, and FIG. 1(a) is a front view, and FIG. 1(b) is a rear view.

An exchange lens 20 is attached onto the front of a body 10.

On the top of the body 10, a release button 101 which is an operation member for picking up images is installed and on the lower part of the release button 101 inside the body 10, a two-step switch composing an AF/AE switch 101a operating at the first step of pressing of the release button 101 and a release switch 101b operating at the second step of pressing of the release button is arranged. Further, on the top of the body 10, a flash light 102 is built in and a mode setting dial 112 for setting the operation mode of the digital camera 1 is arranged.

On the back of the body 10, a power switch 111 for turning on or off the power source for the digital camera 1, a jog dial 115 composed of five switches upward, downward, left, right, and central for executing respective settings in the respective modes of the digital camera 1, a finder eye lens 121a, and an image monitor 131 for displaying recorded images are arranged.

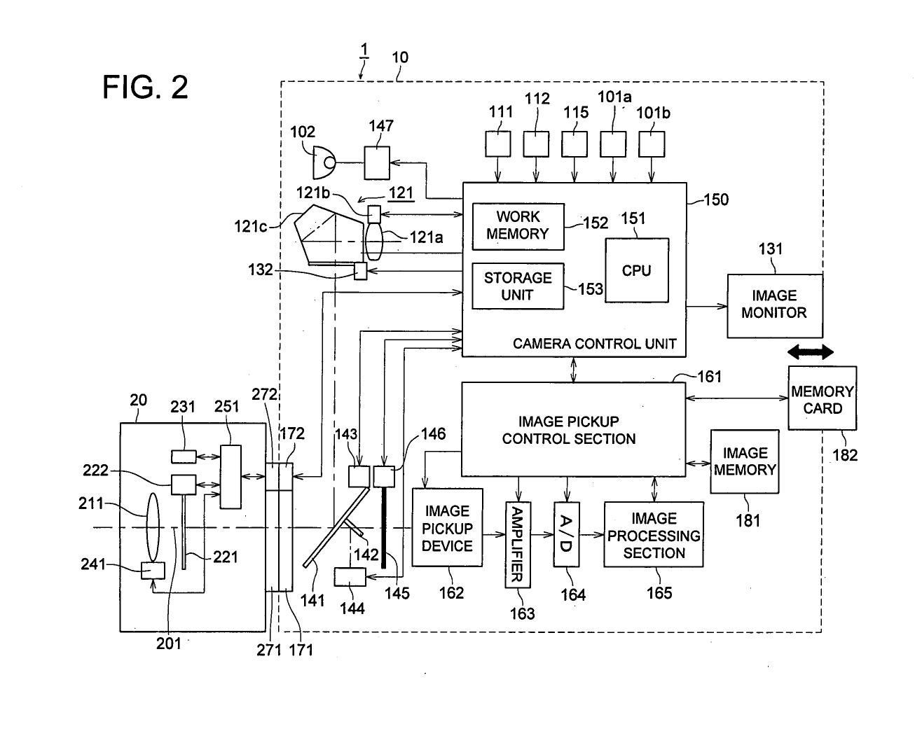

FIG. 2 is a block diagram showing an example of the circuit of the digital camera 1 shown in FIG. 1. In the drawing, the same numbers are assigned to the same parts as those shown in FIG. 1.

A cameral control unit 150 which is a control unit of the digital camera 1 is composed of a central processing unit (CPU) 151, a work memory 152, and a storage unit 152, and reads a program stored in the storage unit 153 into the work memory 152, and intensively controls each unit of the digital camera 1 according to the concerned program.

Further, the cameral control unit 150 receives input signals from the power switch 111, mode setting dial 112, jog dial 115, AF/AE switch 101a, and release switch 101b or the like, communicates with a beam measurement module 121b on an optical finder 121, thereby controls a beam measurement operation, communicates with an AF module 144, thereby controls a focusing operation, drives a reflex mirror 141 and a sub-mirror 142 via a mirror drive unit 143, controls a shutter 145 via a shutter drive unit 146, controls a flash light 102 via a flash control unit 147, communicates with an image pickup control section 161, thereby controls an image pickup operation, displays picked-up image data and various information on an image monitor 131, and displays various information on an in-finder display unit 132.

Furthermore, the camera control unit 150 communicates with a BL communication unit (on the body side) 172 installed on a mount (on the body side) 171 for functioning as a communication unit between the body 10 and the exchange lens 20, a lens control unit 241 for controlling the focus and zoom of a lens 211 via a BL communication unit (on the lens side) installed on a mount (on the lens side) 271 and via a lens interface 251 of the exchange lens 20, a stop control unit 222 for controlling a stop 221, and a lens information storage unit 231 for storing intrinsic information of the exchange lens 20, thereby controls the whole exchange lens 20.

An image focused by the lens 211 of the exchange lens 20 is photoelectrically converted by an image pickup device 162, then is amplified by an amplifier 163, is converted to digital data by an analog-digital (A-D) converter 164, is converted to digital image data subject to a predetermined image process by an image processing section 165, is stored once in an image memory 181, and then is finally stored in a memory card 182.

The image pickup device 162 has a photoelectric conversion characteristic composed of a linear characteristic region and a logarithmic characteristic region and can freely set a range of both characteristic regions (dynamic range). Switching of both characteristics and the range of both characteristic regions (dynamic range) are controlled by the image pickup control section 161. It will be described later in detail.

A series of image pickup operations aforementioned is controlled by the image pickup control section 161 under the control of the camera control unit 150. The cameral control unit 150, image pickup control section 161, image memory 181, and memory card 182 function as an image recording section of the embodiment of the present invention. Further, the camera control unit 150, mode setting dial 112, and jog dial 115 function as a recording format selection section for selecting unprocessed image recording format and processed image recording format of the image recording section of the embodiment of the present invention and also function as an image pickup mode selection section for selecting the normal image pickup mode and wide dynamic range image pickup mode.

Further, digital image data stored in the memory card 182 is read into a personal computer (PC) or a portable information terminal (PDA) which are not drawn, thereby can be subject a further image process by the software of the PC or PDA. By doing this, an image process having a higher performance can be performed by the PC and the like having a more powerful processing capacity than the CPU 151 loaded in the digital camera 1 and a higher image quality can be realized.

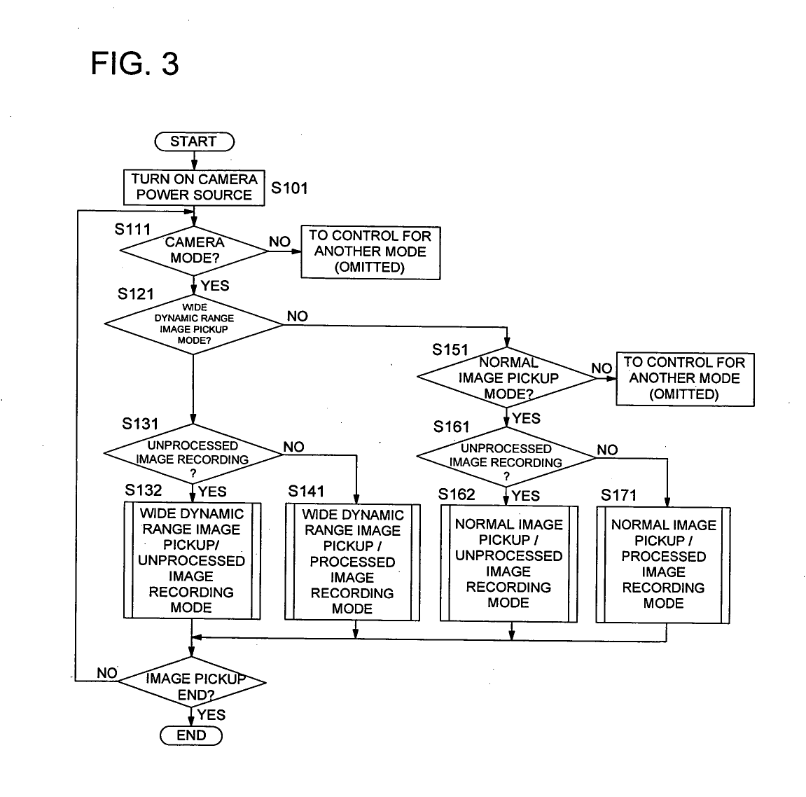

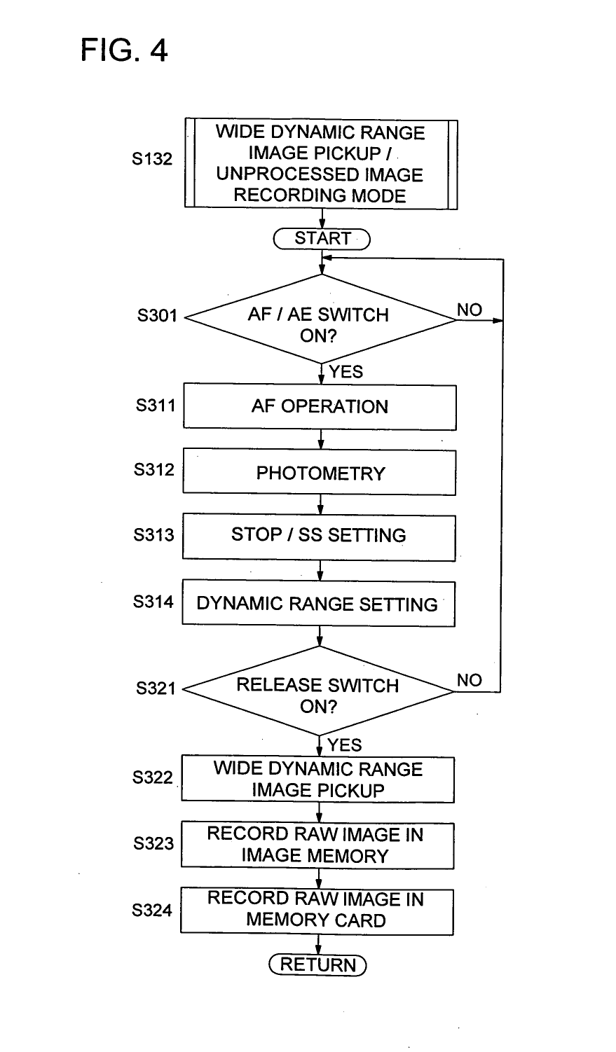

Next, the relationship between the image pickup mode and recording mode and the image process of the digital camera 1 which is an example of the image pickup apparatus relating to the embodiment of the present invention will be explained by referring to FIGS. 3 to 7. FIGS. 3 to 7 are flow charts showing the flow of the image pickup operation of the embodiment of the present invention, and FIG. 3 shows the main routine, and FIGS. 4 to 7 show the sub-routines of the operations in the respective modes.

Further, in this example, the image pickup mode means the normal image pickup mode and wide dynamic range image pickup mode, and the normal image pickup mode means a mode for picking up images only by the linear characteristic of the image pickup device 162, and the wide dynamic range image pickup mode means a mode for picking up images using both linear characteristic and logarithmic characteristic of the image pickup device or using only the logarithmic characteristic.

Further, in this example, the recording mode means the unprocessed image recording mode and processed image recording mode and the unprocessed image recording mode means a mode for recording images not subject to the image process (in this example, it will be explained as RAW image recording), in which images generally are not often subject to image compression but may be subject to image compression such that RAW image data is subject to a reversible compression process. The processed image recording mode means a mode for recording images subject to the image process (in this example, it will be explained as JPEG image recording). Generally, images are often subject to image compression, though images may not be subject to image compression such as bit map.

Further, in this example, the image process includes a predetermined image process and a wide dynamic range image processing.

In FIG. 3, when the power switch 111 is operated at Step S101 and the camera power source is turned on, at Step S111, the operation mode of the digital camera 1 which is set by the mode setting dial 112 is confirmed. When the operation mode is set at the camera mode (YES at Step S111), the process goes to Step S121. When it is set at other than the camera mode (for example, the image reproduction mode, etc.) (NO at Step S111), the process moves to the control in the mode corresponding to the setting. The explanation thereof will be omitted.

At Step S121, it is confirmed whether the image pickup mode in the camera mode of the digital camera 1 is set at the wide dynamic range image pickup mode or not. When it is set at the wide dynamic range image pickup mode (YES at Step S121), the process goes to Step S131.

At Step S131, it is confirmed whether execution of unprocessed image recording in the wide dynamic range image pickup mode is set or not. When the execution of unprocessed image recording is set (YES at Step S131), the process goes to S132, and the subroutine “wide D image pickup/unprocessed recording mode” shown in FIG. 4 is executed, and the process returns to Step S133, and it is confirmed whether or not to end the image pickup. When the image pickup is not to be ended (NO at Step S133), the process returns to Step S11l and it is confirmed whether the operation mode of the digital camera 1 is changed from the camera mode or not. Hereinafter, the flow of operations aforementioned is repeated. When the image pickup is to be ended (YES at Step S133), the camera operation is ended straight.

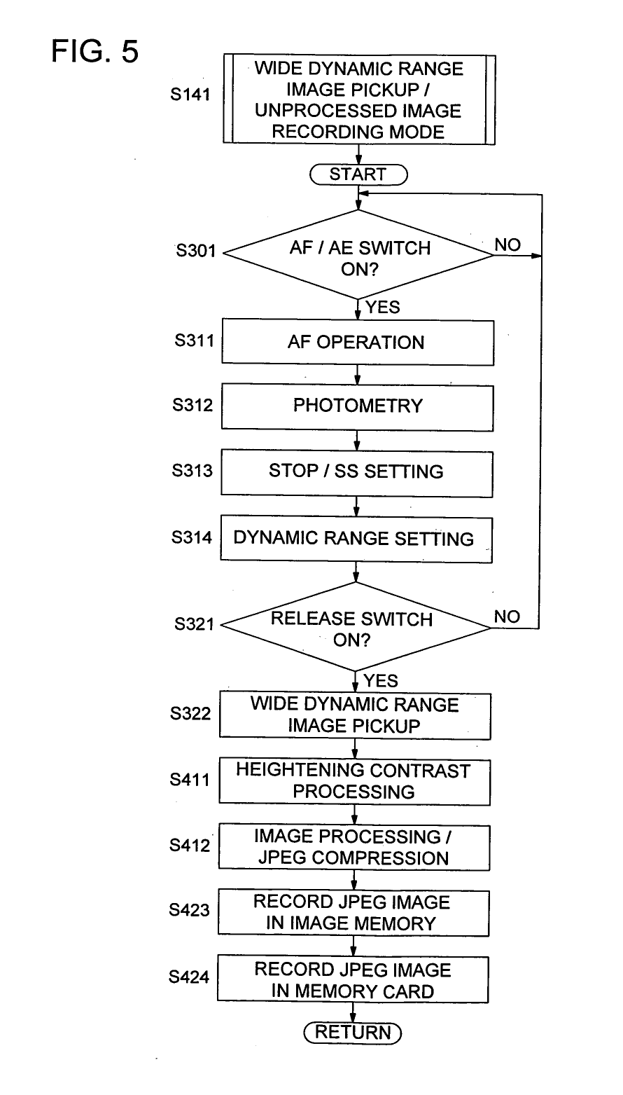

At Step S131, when the execution of unprocessed image recording is not set (NO at Step S131), the process goes to S141, and the subroutine “wide D image pickup/processed recording mode” shown in FIG. 5 is executed, and the process returns to Step S133, and hereinafter, the flow of operations aforementioned is repeated.

When the image pickup mode is not set at the wide dynamic range image pickup mode at Step S121 (NO at Step S121), it is confirmed at Step S151 whether it is set at the normal image pickup mode or not. When it is set at the normal image pickup mode (YES at Step S151), the process goes to Step S161. When it is set at any image pickup mode (for example, the continuous image pickup mode, etc.) other than the normal image pickup mode (NO at Step S151), the process moves to the control in the mode corresponding to the setting. The explanation thereof will be omitted.

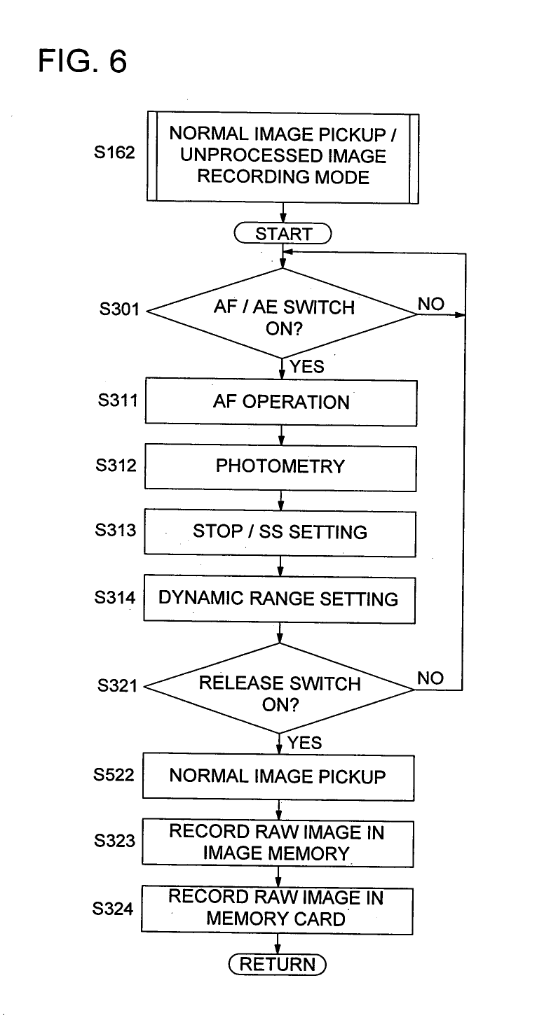

It is confirmed at Step S161 whether the execution of unprocessed image recording is set in the normal image pickup mode or not. When the execution of unprocessed image recording is set (YES at Step S161), the process goes to S162, and the subroutine “normal image pickup/unprocessed recording mode” shown in FIG. 6 is executed, and the process returns to Step S133, and hereinafter, the flow of operations aforementioned is repeated.

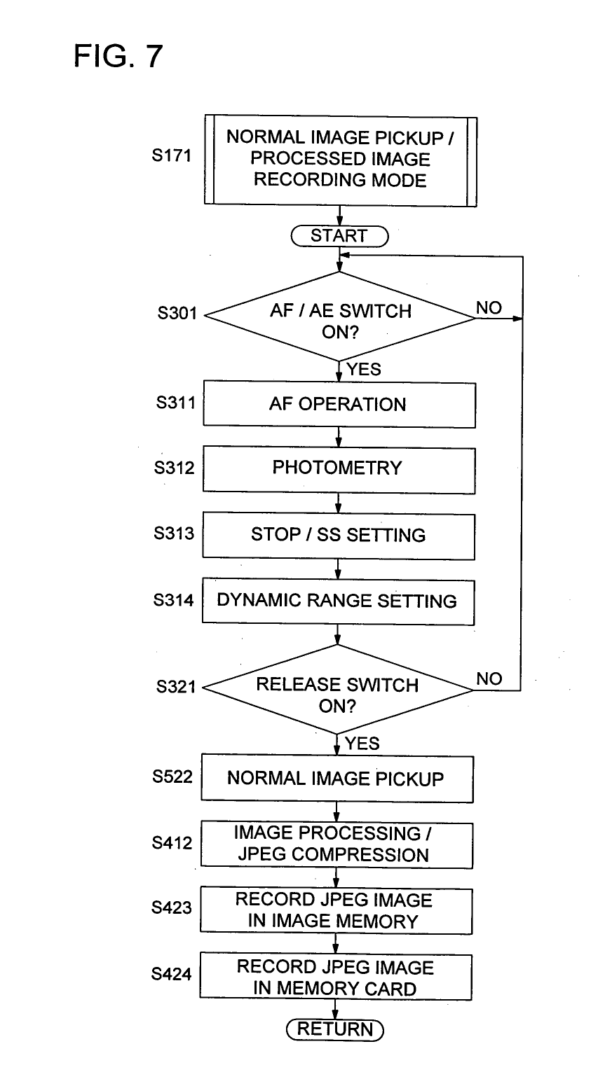

When the execution of unprocessed image recording is not set at Step S161 (NO at Step S161), the process goes to S171, and the subroutine “normal image pickup/processed recording mode” shown in FIG. 7 is executed, and the process returns to Step S133, and hereinafter, the flow of operations aforementioned is repeated.

FIG. 4 shows the sub-routine of the mode for executing the “wide D image pickup/unprocessed recording mode” at Step S132 aforementioned, that is, the wide dynamic range image pickup and executing the unprocessed image recording.

At Step S301, the release button 101 is operated and it is confirmed whether the AF/AE switch 101a is turned on or not. Until it is turned on, the process waits at Step S301. When it is turned on (YES at Step S301), the AF operation is performed at Step S311 and focusing is executed. At Step S312, beam measurement is executed by the beam measurement module 121b and at Step S313, from the beam measurement result, the exposure, that is, the stop value of the stop 221 of the exchange lens 20 and the speed of the shutter 145 are set.

At Step S314, the dynamic range is set in accordance with the exposure set at Step S313. At Step S321, the release button 101 is operated and it is confirmed whether the release switch 101b is turned on or not. Until it is turned on, the flow of operations at Step S301 to Step S321 is repeated. When it is turned on (YES at Step S321), at Step S322, under the condition of the stop value and shutter speed which are set at Step S313 and the dynamic range set at Step S314, the wide dynamic range image pickup is executed, and at Step S323, the picked-up unprocessed image (here, RAW data) and ancillary information of the image (a flag indicating image pickup in the “wide D image pickup/unprocessed recording mode”, etc.) are recorded once in the image memory 181, thereafter at Step S324, the unprocessed image recorded in the image memory 181 and the ancillary information thereof are recorded in the memory card 182, and the process returns to the main routine.

FIG. 5 shows the sub-routine of the mode for executing the “wide D image pickup/processed recording mode” at Step S141 aforementioned, that is, the wide dynamic range image pickup and executing the processed image recording. The same numbers are assigned to the same steps as those shown in FIG. 4 and the explanation thereof will be omitted.

In the “wide D image pickup/processed recording mode”, at Step S411, for the wide dynamic range image picked up at Step S322, the heightening contrast processing which is an example of the wide dynamic range image processing of the embodiment of the present invention is executed (it will be described later in detail), and at Step S412, a series of image processes which will be described later and image compression (here, JPEG compression) are executed, and at Step S423, the processed image processed at Step S412 and ancillary information of the image (a flag indicating image pickup in the “wide D image pickup/processed recording mode”, etc.) are recorded once in the image memory 181, and at Step S424, the processed image recorded in the image memory 181 and the ancillary information thereof are recorded in the memory card 182, and the process returns to the main routine.

FIG. 6 shows the sub-routine of the mode for executing the “normal image pickup/unprocessed recording mode” at Step S162 aforementioned, that is, the normal image pickup and executing the unprocessed image recording. The same numbers are assigned to the same steps as those shown in FIGS. 4 and 5 and the explanation thereof will be omitted.

In the “normal image pickup/unprocessed recording mode”, at Step S522, under the condition of the stop value and shutter speed which are set at Step S313 and the dynamic range set at Step S314, the normal image pickup, that is, the image pickup of operating the image pickup device by the linear characteristic is executed.

FIG. 7 shows the sub-routine of the mode for executing the “normal image pickup/processed recording mode” at Step S171 aforementioned, that is, the normal image pickup and executing the processed image recording. The same numbers are assigned to the same steps as those shown in FIGS. 4 to 6 and the explanation thereof will be omitted.

In the “normal image pickup/processed recording mode”, at Step S522, under the condition of the stop value and shutter speed which are set at Step S313 and the dynamic range set at Step S314, the normal image pickup, that is, the image pickup of operating the image pickup device 162 by the linear characteristic is executed.

As mentioned above, an image pickup apparatus for appropriately selecting and applying two kinds of image processes of a predetermined image process and wide dynamic range image processing in accordance with the image pickup mode and recording mode of the image pickup apparatus, thereby always obtaining optimum images can be provided.

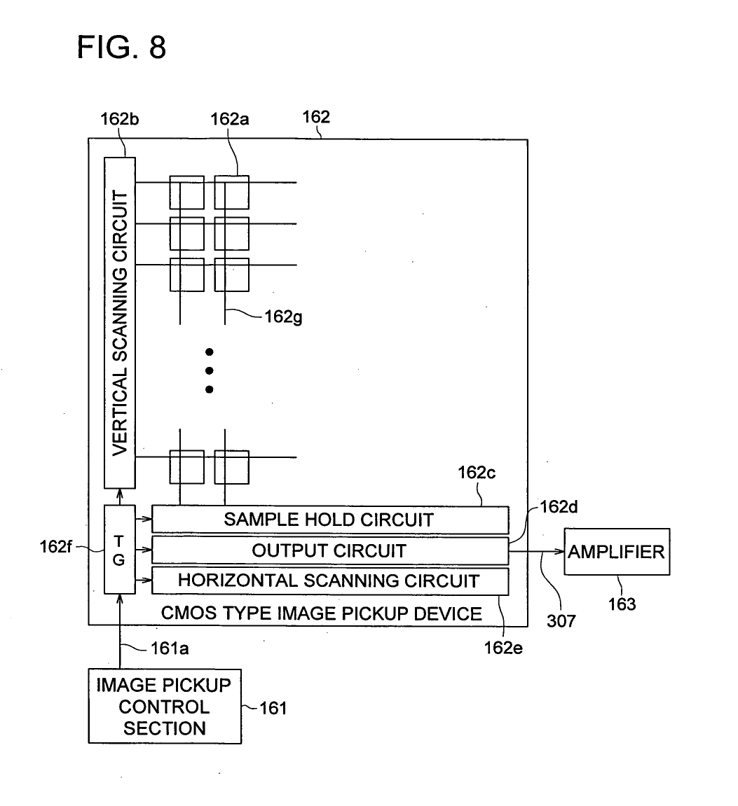

Next, an example of the image pickup device having a photoelectric conversion characteristic composed of a linear characteristic region and a logarithmic characteristic region of the embodiment of the present invention will be explained by referring to FIGS. 8 to 10.

FIG. 8 is a block diagram showing the internal constitution of the image pickup device 162. In the drawing, to the same parts as those shown in FIG. 2, the same numbers are assigned. On the image pickup device 162, pixels 162a are arranged two-dimensionally. Photoelectric conversion output VP of the horizontal pixels 162a selected by a vertical scanning circuit 162b is outputted to a vertical signal line 162g, and the output in correspondence to one line is simultaneously held by a sample hold circuit 162c, is sequentially outputted from an output circuit 162d as image output 307 by scanning of a horizontal scanning circuit 162e, and is input to the amplifier 163. Each operation of the image pickup device 162 is controlled by a timing generator (TG) 162f according to an image pickup control signal 161a from the image pickup control section 161.

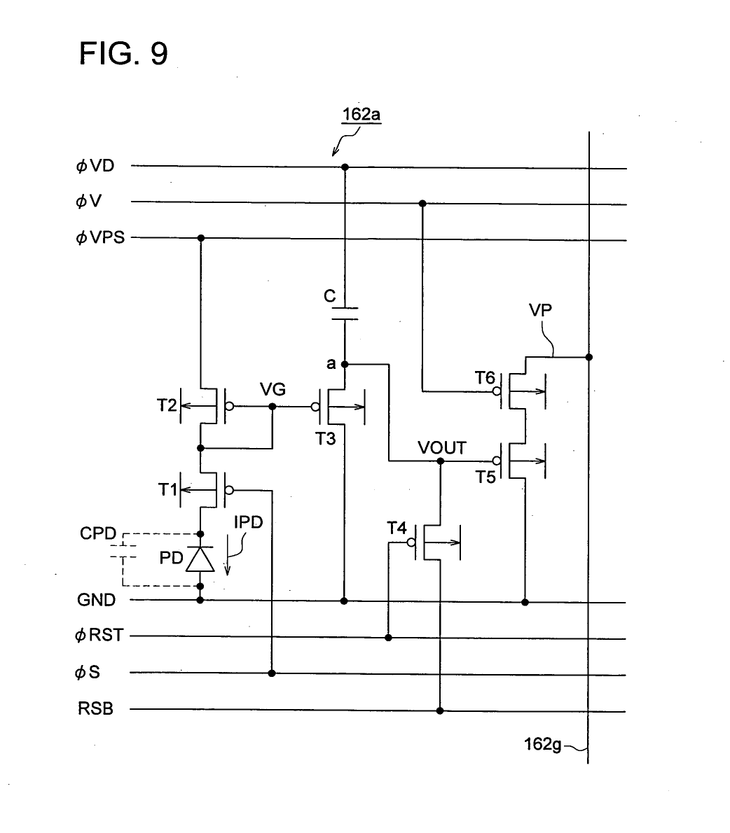

FIG. 9 is a circuit diagram showing an example of the circuit of the pixels 162a having a photoelectric conversion characteristic composed of a linear characteristic region and a logarithmic characteristic region composing the image pickup device 162.

The pixels 162a are composed of a photodiode PD, transistors T1 to T6 as a MOSFET (metal oxide semiconductor field effect transistor), and a capacitor C as an integral capacitor. The transistors T1 to T6 use a P-channel MOSFET in this example. φVD, φV, φVPS, φRST, φS, and RSB indicate signals (voltages) for the transistors and capacitor C and GND indicates grounding.

The photodiode PD is a photoelectric conversion unit and outputs an optical current IPD according to an amount of incident light from a photographic subject.

The transistor T1 is a switch used to take out a pixel variation signal indicating an error component between pixels caused by manufacturing variations of the transistor T2 and is generally kept on so that the optical current IPD flows between the transistor T2 and the photodiode PD. When taking out the pixel variation signal, the transistor T1 is turned off, and the optical current IPD of the photodiode PD is interrupted, and only the pixel variation signal is taken out.

The transistor T2 is connected to a gate and a drain and operates so as to generate a voltage for applying a linear conversion or a logarithmic conversion to the optical current IPD in the gate thereof using a sub-threshold characteristic (a characteristic for flowing a minute current called a sub-threshold current when the gate voltage is not higher than the threshold value) of the MOSFET.

Concretely, when a photographic subject to be picked up is dark, that is, when the amount of incident light entering the photodiode PD is small, since the gate potential of the transistor T2 is higher than the source potential of the concerned transistor, the transistor T2 is in the so-called cutoff state, and the sub-threshold current does not flow in the transistor T2, and the optical current IPD generated by the photodiode PD flows in a parasitic capacity CPD of the photodiode PD, thus the optical current IPD is integrated, and a voltage according to the integral electric charge is generated.

At this time, the transistor T1 is turned on, so that a voltage according to the optical current IPD integrated by the parasitic capacity CPD is generated in the gates of the transistors T2 and T3 as a voltage VG. Due to the voltage VG, a current flows through the transistor T3 and an electric charge in proportion to the voltage VG is accumulated in the capacitor C (the transistorT3 and capacitor C compose an integral circuit). And, at a connection node a between the transistor T3 and the capacitor C, that is, output VOUT, a voltage linearly proportional to the integral value of the optical current IPD appears. This is an operation in the linear characteristic region.

On the other hand, when the photographic subject to be picked up is bright and the amount of incident light entering the photodiode PD is large, the gate potential of the transistor T2 is not higher than the source potential of the concerned transistor, and the transistor T2 is operated in the sub-threshold area, so that the sub-threshold current flows in the transistor T2, and a voltage VG for converting natural-logarithmically the optical current IPD is generated in the gates of the transistors T2 and T3. And, due to the voltage VG, a current flows through the transistor T3 and an electric charge equivalent to a value obtained by natural-logarithmically converting the integral value of the optical current IPD is accumulated in the capacitor C. By doing this, at the connection node a (output VOUT) between the transistor T3 and the capacitor C, a voltage proportional to the value obtained by natural-logarithmically converting the integral value of the optical current IPD is generated. This is an operation of the concerned image pickup device 162 in the logarithmic characteristic region.

As mentioned above, whether the operation of the pixels 162 is in the linear characteristic region or the logarithmic characteristic region depends on the relation of the magnitude between the gate potential VG of the transistor T2 and the source potential φVPS thereof. The gate potential VG depends on the optical current IPD as mentioned above, so that by controlling the source potential φVPS, the switching point (inflection point) between the linear characteristic and the logarithmic characteristic can be controlled.

As mentioned above, according to the brightness of the photographic subject, that is, the amount of incident light, for each pixel, a voltage linearly or natural-logarithmically proportional to the integral value of the optical current IPD is generated.

The transistor T4 is a transistor for resetting the capacitor C and operates as a switch to be turned on or off according to the φRST impressed to the gate of the transistor T4. When the transistor T4 is turned on, a reset voltage RSB is impressed to the capacitor C and the accumulated charge is returned to the state before starting the integration.

The transistor T5 composes a source follower amplifier circuit, executes current amplification for the output VOUT aforementioned, and functions so as to lower the output impedance.

The transistor T6 is a transistor for reading a signal and operates as a switch to be turned on or off according to the voltage φV impressed to the gate. The source gate of the transistor T6 is connected to the vertical signal line 162g and when the transistor T6 is turned on, derives the photoelectric conversion output VP which is amplified in current by the transistor T5 and is reduced in impedance to the vertical signal line 162g.

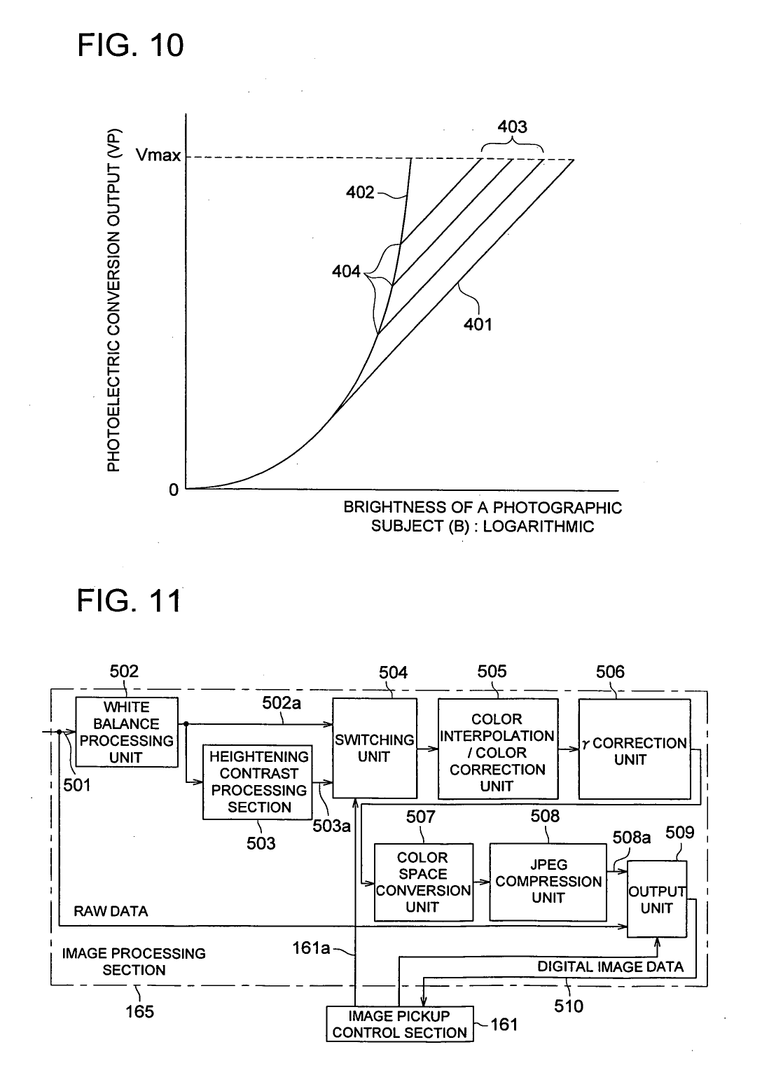

FIG. 10 is a graph showing the photoelectric conversion characteristic of the circuit of the pixels 162a shown in FIG. 9. The axis of abscissa is a logarithmic axis of the brightness of a photographic subject and the axis of ordinate is a linear axis of photoelectric conversion output. As mentioned above, under the control of the source voltage φVSP of the transistor T2 shown in FIG. 9, the logarithmic characteristic as shown by a characteristic 401 in FIG. 10 can be switched to the linear characteristic as shown by a characteristic 402. A characteristic 403, when the brightness of a photographic subject is low, is a linear characteristic similar to the characteristic 402, and when the brightness of the photographic subject is high, it is a linear/logarithmic characteristic (may be referred to as a linear/log characteristic) indicating the same logarithmic characteristic as the characteristic 401, and switching points 404 of the linear characteristic and logarithmic characteristic can be optionally set under the aforementioned control of the source potential 100 VSP of the transistor T2.

Next, the constitution of the image processing section 165 in the circuit block diagram shown in FIG. 2 will be explained by referring to FIG. 11. FIG. 11 is a circuit block diagram showing an example of the circuit constitution of the image processing section 165.

As mentioned above, the image signal converted photoelectrically by the image pickup device 162 is amplified by the amplifier 163, is converted to digital data by the analog-digital (A-D) converter 164, is converted to digital image data subject to a predetermined image process by the image processing section 165, is recorded once in the image memory 181, and then is recorded finally in the memory card 182. Digital data 501 inputted to the image processing section 165 is input to a white balance processing unit 502, and WB output 502a subject to a white balance process is input directly to a switching unit 504 and also input to a heightening contrast processing section 503, and HC output 503a subject a heightening contrast processing is also input to the switching unit 504.

The switching unit 504, under the control of the image pickup control section 161, switches selectively either of the WB output 502a and HC output 503a and inputs it to a color interpolation/color correction unit 505. The image signal subject to color interpolation/color correction is γ-corrected by a γ correction unit 506, is converted from RGB data to YCrCb data by a color space conversion unit 507, is image-compressed by a JPEG compression unit 508, and is input to an output unit 509 as JPEG compressed data 508a. On the other hand, the digital data 501 inputted to the image processing section 165 is directly input to the output unit 509 as RAW data, and either of the JPEG compressed data 508a and RAW data 501 is selectively switched by the output unit 509 under the control of the image pickup control section 161, and it is output to the image pickup control section 161 as digital image data 510.

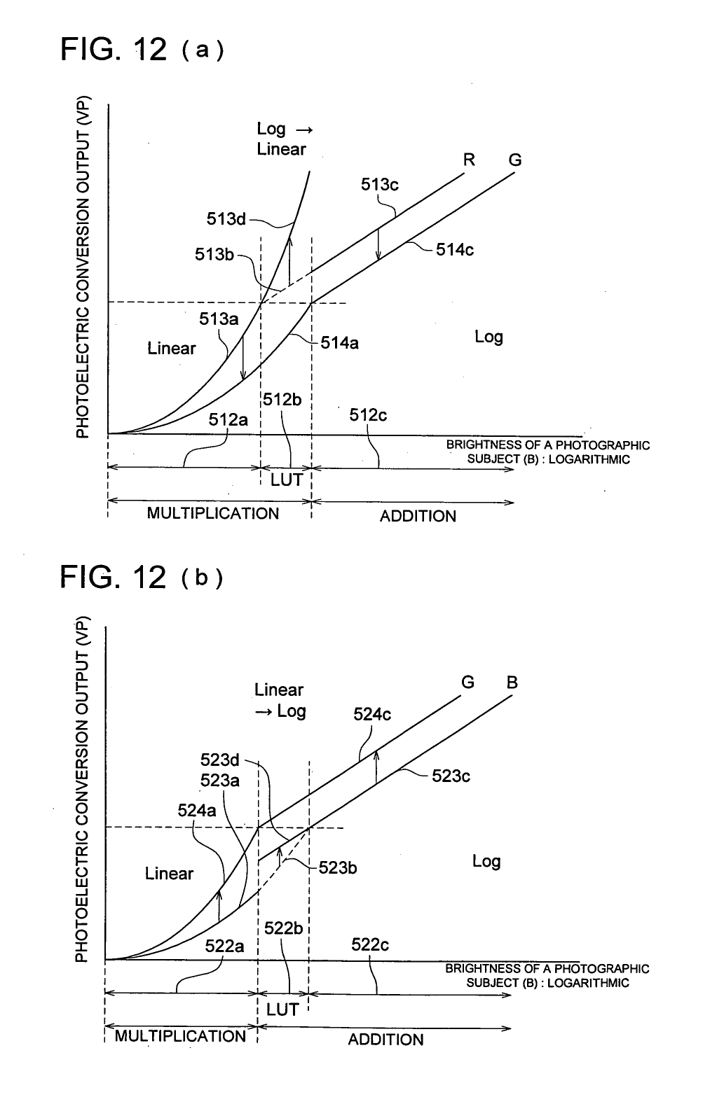

Next, the operation of each unit of the image processing section 165 shown in FIG. 11 will be explained by referring to FIGS. 12 to 15.

FIG. 12 is a graph of the photoelectric conversion characteristic showing the process by the white balance processing unit 502. The white balance process is basically realized by making the photoelectric conversion characteristic of a correction subject (red and blue in this example) coincide with the photoelectric conversion characteristic of the reference color (green in this example). The reason is that when the photoelectric conversion characteristics of the three colors R, G, and B are the same, composition of the three colors produces white. However, actually, due to a difference in the transmission factor of the color filter, for example, as shown in FIG. 12(a), red is higher in the photoelectric conversion characteristic than green and for example, as shown in FIG. 12(b), blue is lower in the photoelectric conversion characteristic than green.

The white balance process in such a case will be explained, for example, by referring to FIG. 12(a) as an example. In FIG. 12(a), in a photographic subject brightness area 512a, both a photoelectric conversion characteristic 514a of green and a photoelectric conversion characteristic 513a of red are a linear characteristic. In a photographic subject brightness area 512b, the photoelectric conversion characteristic 514a of green is a linear characteristic and the photoelectric conversion characteristic 513b of red is a logarithmic characteristic. In a photographic subject brightness area 512c, both a photoelectric conversion characteristic 514c of green and a photoelectric conversion characteristic 513c of red are a logarithmic characteristic. Generally, in the case of the linear characteristic, the white balance can be made coincide with the reference color by multiplying the photoelectric conversion output of a color to be corrected by a correction value. In the case of the logarithmic characteristic, the white balance can be made coincide with the reference color by adding a correction value to the photoelectric conversion output of a color to be corrected.

Therefore, in this example, firstly, the photoelectric conversion characteristic 513b of the logarithmic characteristic of red in the area 512b is calculated and converted to a linear characteristic 513d and is connected to the linear characteristic 513a of the photographic subject brightness area 512a (513a+513d). In an actual conversion, a lookup table (LUT) and the like is used to shorten the time necessary for calculation. Thereafter, the linear characteristic with the photographic subject brightness areas 512a and 512b connected to each other is multiplied by a correction value, thus the photoelectric conversion characteristic (513a+513d) of the linear characteristic region is made coincide with the photoelectric conversion characteristic 514a of the reference color of green. The logarithmic characteristic 513c of the photographic subject brightness area 512c is added with a correction value (a negative correction value is added in this example) and is made coincide with the photoelectric conversion characteristic 514c of the reference color of green. By doing this, the photoelectric conversion characteristic of red is made coincide with the photoelectric conversion characteristic of green.

Further, in the example shown in FIG. 12(b), in a photographic subject brightness area 522a, both a photoelectric conversion characteristic 524a of green and a photoelectric conversion characteristic 523a of blue are a linear characteristic. In a photographic subject brightness area 522b, a photoelectric conversion characteristic 524c of green is a logarithmic characteristic and a photoelectric conversion characteristic 523b of blue is a linear characteristic. In a photographic subject brightness area 522c, both the photoelectric conversion characteristic 524c of green and a photoelectric conversion characteristic 523c of red are a logarithmic characteristic. Therefore, firstly, the photoelectric conversion characteristic 523b of the linear characteristic of blue in the area 522b is converted to a logarithmic characteristic 523d by calculation using the LUT and is connected to the logarithmic characteristic 523c of the photographic subject brightness area 522c (523d+523c). Thereafter, the logarithmic characteristic with the photographic subject brightness areas 522b and 522c connected to each other is added with a correction value, thus the photoelectric conversion characteristic (523d+523c) of the logarithmic characteristic region is made coincide with the photoelectric conversion characteristic of the reference color of green. The linear characteristic 523a of the photographic subject brightness area 522a is multiplied by a correction value and is made coincide with the photoelectric conversion characteristic 524a of the reference color of green.

As mentioned above, the white balance processing unit 502 calculates the photoelectric conversion characteristic of the color to be corrected to data of the same characteristic in accordance with the linear characteristic region and logarithmic characteristic region of the photoelectric conversion characteristic of the reference color and multiplies or adds for each of the linear characteristic region and logarithmic region so as to make the photoelectric conversion characteristics coincide with each other.

Next, the heightening contrast processing (gradation conversion process) by the heightening contrast processing section 503 shown in FIG. 11 will be described in detail.

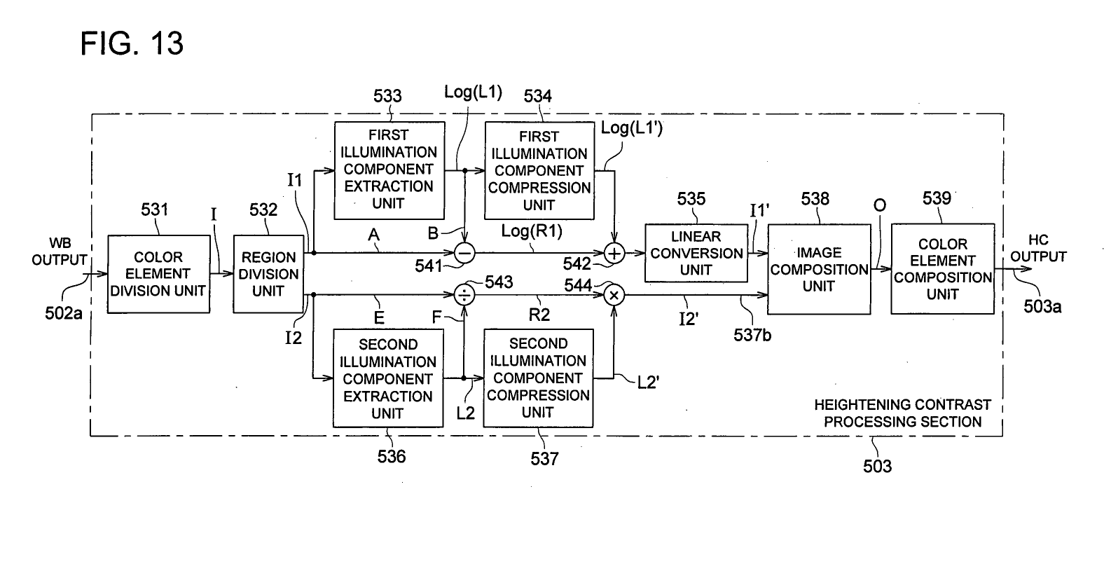

FIG. 13 is a function block diagram for explaining the function of the heightening contrast processing section 503. As shown in the drawing, the heightening contrast processing section 503 includes a color element division unit 531, an region division unit 532, a first illumination component extraction unit 533, a first illumination component compression unit 534, a linear conversion unit 535, a second illumination component extraction unit 536, a second illumination component compression unit 537, an image composition unit 538, and a color element composition unit 539. Hereinafter, these function units will be explained together with a concrete calculation method.

The color element division unit 531 divides image data from the image pickup device 162, here, the WB output 502a (linear/logarithmic image) from the preceding white balance processing unit 502 into image data for each four color elements (R, Gr, Gb, B) in the G checkered RB line sequential arrangement having a Bayer system color filter structure, that is, obtains four kinds of color image data (R image, Gr image, Gb image, and B image) derived by dividing the four Bayer elements into each elements. Further, the image size of each color image is ½ of the original image size. Further, the four kinds of color images are respectively linear/logarithmic images including linear characteristic and logarithmic characteristic information.

The region division unit 532, from each of the four kinds of color images input from the color element division unit 531 (each color image is expressed as a basic image I), divides and extracts images in the logarithmic characteristic region (assumed as an image I1) and images in the linear characteristic region (an image I2).

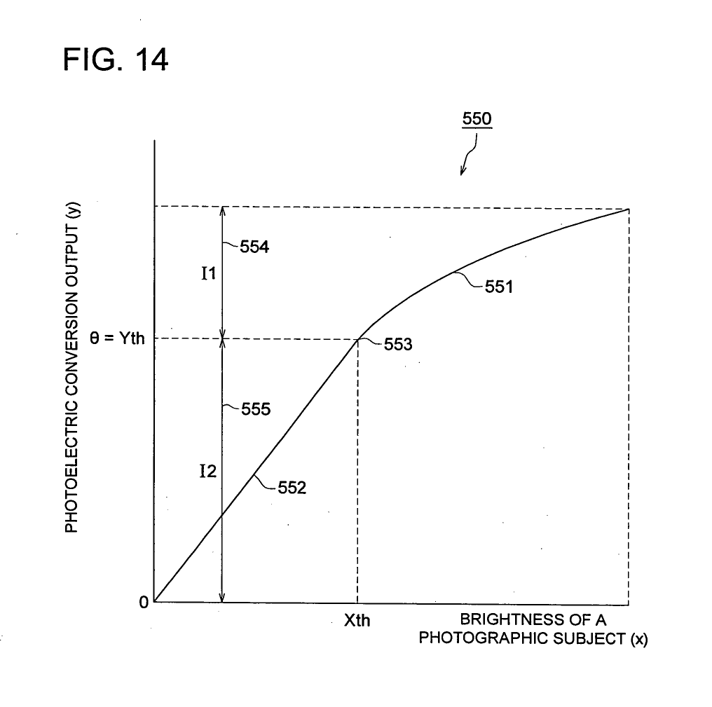

The basic image I for each color image input from the color element division unit 531 to the region division unit 532 has, for example, a photoelectric conversion characteristic 550 shown in FIG. 14 and the photoelectric conversion characteristic 550 is expressed by Formulas (1-1) and (1-2) indicated below as photoelectric conversion output y to photographic subject brightness x (not a logarithmic value). The coordinates Xth and Yth shown in the drawing indicate coordinates (x, y) at the switching point between a logarithmic character region 551 and a linear characteristic region 552, that is, an inflection point 553.
y=α×x+b (where 0≦x≦Xth) (1-1)
y=α×log(x)+β(where Xth≦x) (1-2)

In the region division unit 532, as shown in Conditional Expressions (2-1) to (2-4) indicated below, the pixels composing the basic image I (here, to indicate a two-dimensional image, may be properly expressed as image I (x, y)) are divided into an region where the photoelectric conversion output is a predetermined value θ or larger and an region where it is smaller than θ (the basic image I is clipped (so-called clipping) by θ at the upper limit position and lower limit position of each characteristic region). The “θ” is properly referred to as a division parameter.
if (I(x, y)≧θ)

then
I1(x,y)=I(x,y) (2-1)
I2(x,y)=0(zero) (2-2)

else
I1(x,y)=0(zero) (2-3)
I2(x,y)=I(x,y) (2-4)

The conditional expressions, in short, indicate that in the image I (x, y), the image in the region where the photoelectric conversion output is θ or larger is the image I1 (image I1 (x, y)) and the image in the region where the photoelectric conversion output is smaller than θ is the image I2 (image I2 (x, y)).

However, in this example, as shown in FIG. 14, the overall image having the photoelectric conversion characteristic 550 is divided into the image in the linear characteristic region and the image in the logarithmic characteristic image, so that the position of the division parameter θ is the same position as that of Yth at the inflection point aforementioned (the division parameter θ is fixed and set only to the value of Yth). Therefore, the boundary position between the linear characteristic and the logarithmic characteristic in the division extraction process may not be set using the division parameter θ and for example, may be set just as a position of the inflection point Yth.

As mentioned above, the region division unit 532, when a basic image I having the photoelectric conversion characteristic 550 is input, from the concerned basic image I, performs the division extraction process of the image I1 (logarithmic characteristic image) shown in an region 554 and the image I2 (liner characteristic image) shown in an region 555 with the position of the division parameter θ (=Yth, the inflection point) bounded by. The setting information of the boundary parameter θ may be stored in the heightening contrast processing section 503 (for example, the region division unit 532).

On the other hand, the basic image I, according to the so-called Retinex theory, assuming the illumination component of the basic image I as L and the reflection factor component as R, is expressed by Formula (3-1) indicated below.
I=L×R (3-1)

However, Formula (3-1) is a formula for the basic image I as a linear characteristic region image and the basic image I as a logarithmic characteristic region image is expressed by Formula (4-1) indicated below.
Log(I)=Log(L)+Log(R) (4-1)

As shown in FIG. 14, the image I1 in which the photoelectric conversion output of the basic image I is θ (=Yth) or larger is the image in the logarithmic characteristic region 551 equivalent to the aforementioned Formula (1-2) in the region 554, so that Formula (4-1) is held. It may be rewritten to Formula (4-2) indicated below. The image I2 is the image in the linear characteristic region 552 equivalent to the aforementioned Formula (1-1) in the region 555, so that Formula (3-1) is held. It may be rewritten to Formula (3-2) indicated below.
I2=L1×R2 (3-2)
I1=Log(L1)+Log(R1) (4-2)

Generally, the illumination component is often lower in the frequency than the reflection factor component, so that the illumination component is approximated to the low frequency component of an image. A low frequency component extraction filter (low-pass filter) is assumed as F. F is a Gaussian filter, a median filter, an ε-filter which is an edge maintaining type low-pass filter, or a bilateral filter. Formula (4-2), when F is applied, since the high frequency component Log (R1) is removed, is changed to:
Log(L1)=F(I1) (5-1),

thus, the light can be obtained.

The first illumination component compression unit 534 performs the compression process for the illumination component image extracted by the first illumination component extraction unit 533. Namely, the first illumination component compression unit 534 performs a predetermined compression process for the illumination component Log (L1) extracted and outputs it as a logarithmic value Log (L1′) of a illumination component L1′ obtained by compressing the illumination component L1. Assuming the compressibility for heightening contrast realization processing (dynamic range compressibility) as c and the parameter for controlling the reproduction dynamic range as s, the Log (L1′) outputted from the first illumination component compression unit 534 is indicated by the following Formula (6-1).
Log (L1′) Log (L1)×c+Log (s) (6-1)

Assuming the image after heightening contrast realization processing for the image I1 as image I1′ and the reflection factor component of the image I1 as R1, Formula (4-1) is expressed by Formula (7-1) indicated below.
Log(I1′)=Log(L1′)+Log(R1) (7-1)

Therefore, the image I1′ is expressed by the following Formula (8-1) obtained by taking an inverse logarithm for both sides of Formula (7-1).
I1′=exp(Log(L1′)+Log(R1))=L1′×R1 (8-1)

The linear conversion unit 535 converts the logarithmic image which is divided and extracted by the region division unit 532 and is compressed by the first illumination component extraction unit 533 and the first illumination component compression unit 534 to a linear image. Concretely, the linear conversion unit 535 performs calculations by conversion of Formula (7-1) to Formula (8-1), thereby converts the logarithmic image Log (I1′) to the linear image I1′. When the logarithmic image Log (I1′) is converted to the linear image I1′ by the linear conversion unit 535 like this, it can be handled as an image having the same characteristic (linear characteristic) as that of the image I2′ which is a succeeding linear image (here, a composition process of the images I1′ and I2′ can be performed).

Further, as shown in FIG. 13, the Log (R1) aforementioned is obtained by subtracting the illumination component Log (L1) transmitted through a route B from the image I1 transmitted through a route A by a subtraction unit 541. Further, the image I1′ is obtained by adding the compression illumination component Log (L1′) from the first illumination component compression unit 534 and the reflection factor component Log (R1) from the subtraction unit 541 by an addition unit 542. Further, in the above description, an expression that the image is transmitted through the route is used, though in the actual operation, an image data signal (video signal) is impressed to the concerned overall route.

Among the images I1 and I2 extracted by the region division unit 532, the image I2 is subject to heightening contrast processing by the method indicated below by the second illumination component extraction unit 536 and second illumination component compression unit 537 and is input to the image composition unit 538 as an image I2′. It will be explained below.

The second illumination component extraction unit 536 extracts the illumination component L2 from the image L2 divided and extracted by the region division unit 532. The extraction process of the illumination component L2 from the concerned image L2 is expressed by Formula (9-1) indicated below.
L2=F(I2) (9-1)

F in Formula (9-1), similarly to the aforementioned, indicates a filter such as a Gaussian filter. On the other hand, the reflection factor component R2 of the image I2 is obtained from the relationship of R2=I2/L2 (refer to Formula (3-2)).

The second illumination component compression unit 537 performs a predetermined compression process for the illumination component L2 obtained by the second illumination component extraction unit 536 and outputs a illumination component L2′ obtained by compressing the concerned illumination component. Assuming the dynamic range compressibility as c and the parameter for controlling the reproduction dynamic range as s, the compression illumination component L2′ is given by Formula (10-1) indicated below.
L2′=exp (Log (L2)×c+Log (s)) (10-1)

The compression illumination component L2′ obtained by the second illumination component compression unit 537 is multiplied by the reflection factor component R2 by a multiplication unit 544 and as a result, the image I2′ after the heightening contrast processing for the image I2 is obtained. The reflection factor component R2 is obtained by dividing the illumination component L2 transmitted through a route F by the image I2 transmitted through a route E by a division unit 543.

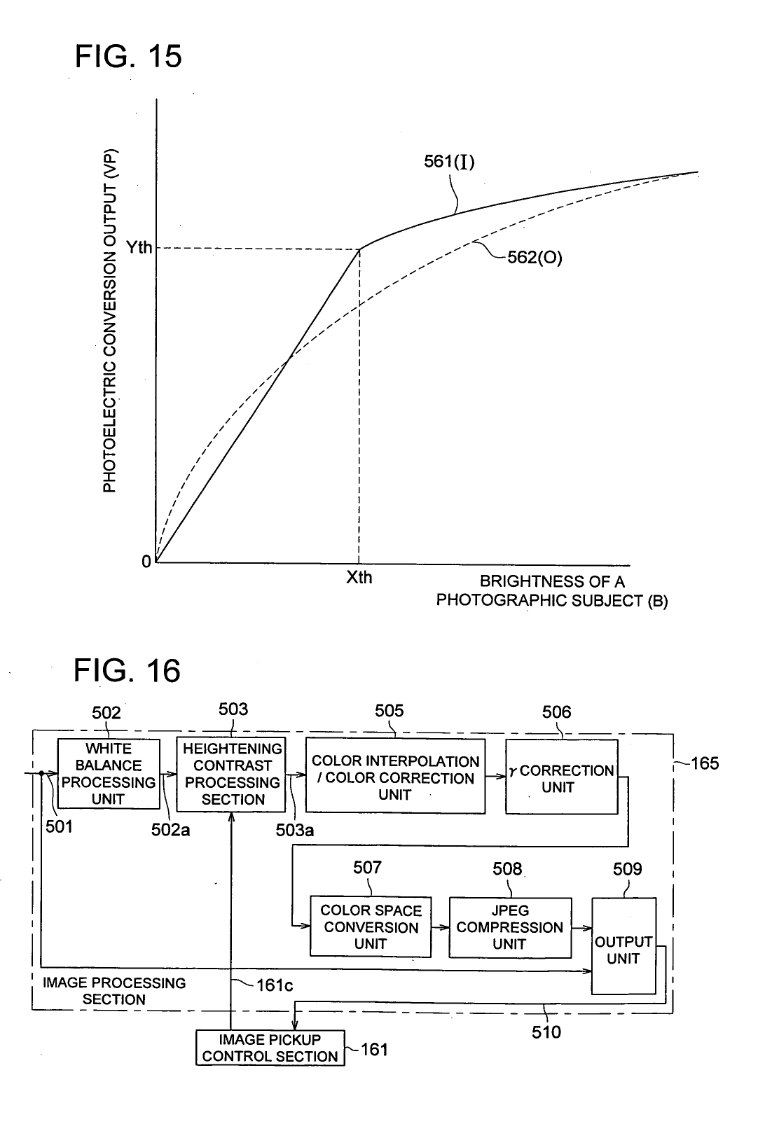

The image composition unit 538 prepares a composite image of the linear image and logarithmic image after the heightening contrast processing aforementioned. Namely, the image composition unit 538 prepares a composite image O on the basis of the image I1′ obtained by the heightening contrast processing for the image I1 and the image I2′ obtained by the heightening contrast processing for the image I2 (O=I1′+I2′). The image I1′ (logarithmic characteristic image) and the image I2′ (linear characteristic image) are smoothly connected (composed) as indicated by a photoelectric conversion characteristic 562 (O) shown in FIG. 15.

The color element composition unit 539 composes the image O obtained by the image composition unit 538, that is, four kinds of images O corresponding to the respective color image I (R image, Gr image, Gb image, and B image aforementioned) for each element of the four Bayer elements aforementioned and obtains the HC output 503a (linear image) having the image information of the original four elements. Further, the image size is returned from the ½ size of each image O to the HC output 503a of the equimultiple size. Further, the HC output 503a is an image including only the linear characteristic information (unified to image data of the linear characteristic).

The image pickup device having the linear characteristic and logarithmic characteristic is explained above, though in the case of an image pickup device having the logarithmic characteristic, it is desirable to perform only the process of image I1 (logarithmic character image) aforementioned. Further, various methods for obtaining a wide dynamic range image of the linear characteristic have been proposed, though for those images, it is desirable to perform only the process of I2 (linear characteristic image) aforementioned.

As mentioned above, when the heightening contrast processing (gradation conversion process) by the heightening contrast processing section 503 is performed, images having different photoelectric conversion characteristics can be converted to images having the same photoelectric conversion characteristic and contrast emphasis (contrast improvement) of a low-contrast part of a picked-up image can be realized. Namely, a process (process by the linear conversion unit 535) of extracting the base (illumination component) for each local space (the linear characteristic region and logarithmic characteristic region) of an image, compressing the concerned extracted base, and converting it to the same photoelectric conversion characteristic as that of the linear characteristic region together with the reflection factor component of the image is performed, thus the image data composed of the logarithmic character and linear character can be unified to image data of the linear characteristic, and in addition to it, contrast emphasis (improvement) in the logarithmic characteristic region can be realized.

In any way, by the heightening contrast processing by the heightening contrast processing section 503, picked-up image data is unified to the photoelectric conversion characteristic in the low-brightness area, thus all the image data can be processed as image data having the same characteristic, and the processing of data in the subsequent image process is simplified (the calculation can be simplified or the processing can be speeded up). Here, the subsequent processes by the color interpolation/color correction unit 505, γ correction unit 506, and color space conversion unit 507 can be performed efficiently using the conventional color processing method as it is. Next, the functions of the switching unit 504 of the image processing section 165 and subsequent units will be explained by referring to FIG. 11. FIG. 11, as mentioned above, is a circuit block diagram showing an example of the circuit constitution of the image processing section 165.

The switching unit 504, according to the image pickup mode of the digital camera 1 explained in FIG. 3 and the switching control signal 161a from the image pickup control section 161, switches selectively and inputs either of the WB output 502a and HC output 503a to the color interpolation/color correction unit 505. When the image pickup mode is set at the normal image pickup (image pickup in the linear characteristic) mode, the WB output 502a not subject to the heightening contrast processing is selected and when it is set at the wide dynamic range image pickup mode, the HC output 503a subject to the heightening contrast processing is selected. Thus, the parameter setting section for setting the process parameter of the wide dynamic range image processing is composed of the image pickup control section 161 and the switching unit 504.

The processes by the color interpolation/color correction unit 505, γ correction unit 506, and color space conversion unit 507 following the switching unit 504, as mentioned above, can use the conventional color processing method as it is, so that the explanation thereof will be omitted here. Further, for the JPEG compression unit 508 which is an example of image compression, since both WB output 502a and HC output 503a are image data of the linear characteristic, the known JPEG compression method can be used, so that the explanation thereof will be omitted.

In the output unit 509, the processes by the color interpolation/color correction unit 505, γ correction unit 506, and color space conversion unit 507 are performed for the aforementioned WB output 502a or HC output 503a and the processed image data 508a subject to JPEG compression and the unprocessed image data (RAW data) input to the image processing section 165 are input to it. From the output unit 509, according to an output control signal 161b from the image pickup control section 161 and in accordance with the image pickup mode and recording mode of the image pickup apparatus, either of the processed image data 508a and unprocessed image data (RAW data) 501 is output toward the image pickup control section 161 as digital image data 510, is stored once in the image memory 181 by the image pickup control section, and, then is finally stored in the memory card 182.

In the above explanation, the switching unit 504 switches and outputs the WB output 502a and HC output 503a according to the image pickup mode. A method for practically switching the WB output 502a and HC output 503a according to the image pickup mode without using the switching unit 504 will be explained below.

When the image pickup mode is the normal image pickup (image pickup in the linear characteristic) mode and the maximum value of the input range of the WB output 502a which is an input signal of the heightening contrast processing section 503 is set to a photoelectric conversion output value Yth at the switching point between the linear characteristic and the logarithmic characteristic, use of only the lower half (the processing series of the linear image I2) shown in FIG. 13 can be set, thus the input image I of the region division unit 532 is changed to I2 and the composite image O which is output of the image composition unit 538 is changed to 12′.

When the coefficient of the filter F (I2) of the second illumination component extraction unit 536 is set to 1 only for its own pixel and 0 (zero) for the others, from Formula (9-1), L2=I2 is held and the reflection factor component R2=I2/L2=I2/I2=1 is held.

Therefore, when c=1 is set in Formula (10-1), the output of the second illumination component compression unit 537 L2′=L2=I2 is held. Therefore, the composite image O==I2′=R2×L2′=1×I2=I2=I is held and the composite image O becomes equal to the input image I, that is, the process by the heightening contrast processing section 503 is not acted practically (made invalid).

When the process parameter of the heightening contrast processing section 503 is appropriately controlled in the normal image pickup (image pickup in the linear characteristic) mode like this, the switching unit 504 can be made unnecessary and it can contribute to realization of miniaturization and low cost of the image processing section 165. The circuit block diagram of the image processing section 165 when the switching unit 504 is not used is shown in FIG. 16. Except that the switching unit 504 is deleted and the parameter control signal 161c for controlling the process parameter of the heightening contrast processing section 503 is input to the heightening contrast processing section 503 from the image pickup control section 161 and that the parameter setting section is composed of the image pickup control section 161, the circuit block diagram is the same as that shown in FIG. 11, so that the explanation thereof will be omitted.

Furthermore, an image after the image process which is recorded in the image memory 181 or memory card 182 can be confirmed by the image monitor 131 loaded on the digital camera 1 or a monitor such as a PC or a PDA reading an image in the digital camera 1 and memory card 182. Further, it may be considered to confirm by printing it by a printer.

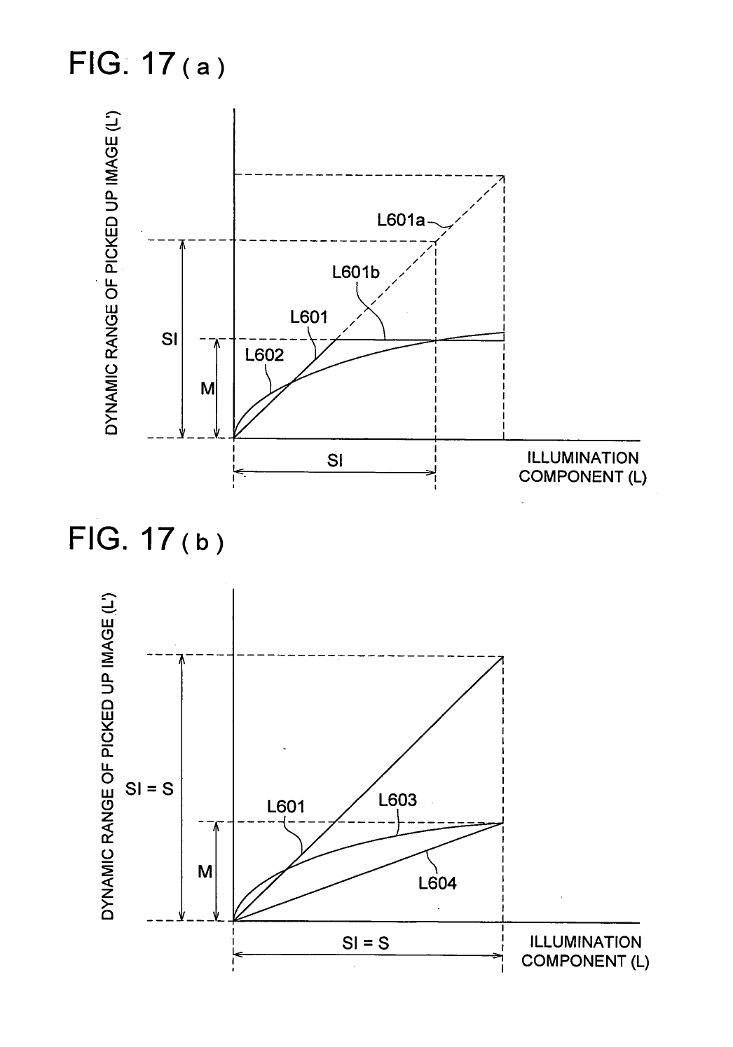

As a result of confirmation of the image, depending on the image pickup scene and condition, a case that the compressibility of the dynamic range or the dynamic range reproduction range is required to be changed or a case that although an image is picked up in the wide dynamic range image pickup mode, an image picked up in the normal image pickup mode is desirable occurs. According to the embodiment of the present invention, in such a case, when the parameter of the heightening contrast processing section 503 aforementioned is reset, a desired image can be obtained without picking up an image again. Hereinafter, one example of the method will be indicated by referring to FIG. 17. FIG. 17 is a graph showing changes in the image output due to resetting of the parameter of the heightening contrast processing section 503.

The dynamic range and contrast are affected greatly by the compressing method and compressibility of the illumination component and images are varied greatly with the setting thereof. The aforementioned process by the heightening contrast processing section 503, after all from Formulas (6-1) and (10-1), is equivalent to execution of the dynamic range compression given by Formula (11-1) indicated below for the illumination component L linearly converted.
L′=s×Lc (11-1)

Here, assuming the reproduction dynamic range capable of reproducing monitor and print as M and the reproduction dynamic range to be reproduced for monitor and print in an image as SI, the parameter s for controlling the reproduction dynamic range is expressed by Formula (11-2) indicated below from Formula (11-1) and Formula (11-1) is rewritten to Formula (11-3).
s=M/SIc (11-2)
L′=M×(L/SI)c (11-3)

When M=SI and c=1 are set in Formula (11-3), L601 shown in FIG. 17(a), that is, the illumination component linearly converted is obtained. When displaying L601 on the monitor, a part L601a larger than the characteristic value M is an image L601b clipped at M. It is similar to an image picked up by setting the exposure to the low brightness part by an image pickup device having the normal linear characteristic, that is, an normally picked up image.

Further, when c≦1 is held, L602 shown in FIG. 17(a) is obtained. L602 can control the contrast by the value of s (=M/SIc), that is, c and as c is reduced, the contrast is increased. In the case of L602, a comparatively high contrast is obtained easily, though the reproduction range (dynamic range) is narrow.

Furthermore, when the reproduction dynamic range S1 is enlarged overall the picked-up image (SI=S), FIG. 17(b) is obtained. Here, when c<1 in Formula (11-3), L603 is obtained and by the dynamic range compression art, an image in which the low brightness part is reproduced similarly to an image pickup device of the linear characteristic and the high brightness part can obtain a comparatively high contrast free of white collapse is obtained. However, in correspondence to the wide reproduction dynamic range SI, the contrast is low compared with L602. L603, similarly to L602, can control the contrast by the value of c and as c is reduced, the contrast is increased.

When SI=S and c=1 in Formula (11-3), L604 shown in FIG. 17(b) is obtained. L604 has the same characteristic as that when an image is picked up by setting the exposure to the high brightness part by an image pickup device having the normal linear characteristic and as a whole, it is an image having a wide dynamic range and a low contrast.

As mentioned above, when the parameter s for controlling the reproduction dynamic range and the dynamic range compressibility c are reset again for an image which is picked up and is recorded in the image memory 181 or the memory car 182, an image having a changed reproduction dynamic range, a changed contrast, and a different appearance can be obtained freely without picking up an image again.

According to the embodiment of the present invention, an image pickup apparatus for performing selectively two image processes of a predetermined image process and a wide dynamic range image processing in accordance with two image pickup modes of normal image pickup and wide dynamic range image pickup and two recording formats of unprocessed image recording format and processed image recording format, thereby always obtaining optimum images can be provided.

According to another side of the embodiment of the present invention, an image pickup apparatus, when the normal image pickup mode and processed image recording format are selected, for performing the normal image processing by the image processing section, thereby always obtaining optimum images can be provided.

According to still another side of the embodiment of the present invention, an image pickup apparatus, when the wide dynamic range image pickup mode and processed image recording format are selected, for performing the normal image processing and wide dynamic range image processing by the image processing section, thereby always obtaining optimum images can be provided.

According to a further side of the embodiment of the present invention, an image pickup apparatus for using an image pickup device having a linear characteristic region and a logarithmic characteristic region for controlling the range of the linear characteristic region and logarithmic characteristic region and controlling so as to have only the linear characteristic to select an normal image pickup mode and the linear characteristic region and logarithmic characteristic region to select a wide dynamic range image pickup mode, thereby always obtaining optimum images can be provided.

According to a still further side of the embodiment of the present invention, an image pickup apparatus for using a process of heightening contrast for an image picked up in a wide dynamic range image pickup mode as a wide dynamic range image processing, thereby always obtaining optimum images can be provided.

According to yet a further side of the embodiment of the present invention, an image pickup apparatus for using a process of converting an image picked up in a wide dynamic range image pickup mode to an image picked up in an normal image pickup mode as a wide dynamic range image processing, thereby always obtaining optimum images can be provided.

According to yet a further side of the embodiment of the present invention, an image pickup apparatus for switching an image processing path for performing a wide dynamic range image processing and an image processing path for not performing the wide dynamic range image processing in accordance with an image pickup mode, thereby always obtaining optimum images can be provided.

According to yet a further side of the embodiment of the present invention, an image pickup apparatus for setting the process parameter of a wide dynamic range image processing so as to make the process invalid in an normal image pickup mode, thereby always obtaining optimum images can be provided.

According to yet a further side of the embodiment of the present invention, an image pickup apparatus for compressing data as an normal image processing, thereby always obtaining optimum images can be provided.

According to yet a further side of the embodiment of the present invention, an image pickup apparatus, when unprocessed image recording format is selected, for performing neither an normal image processing nor a wide dynamic range image processing, thereby always obtaining optimum images can be provided.

As describe above, according to the embodiment of the present invention, an image pickup apparatus, when picking up an image using an image pickup device having a photoelectric conversion characteristic composed of a linear characteristic region and a logarithmic characteristic region, for performing an appropriate image process according to an image pickup mode and a recording mode, thereby always obtaining optimum images can be provided.

Further, while the present invention has been described by reference to specific embodiments, it should be understood that modifications and variations of the invention may be constructed without departing from the scope of the present invention.

What is claimed is:

1. An image pickup apparatus, comprising:
an image pickup device which takes an image of a photographic subject and outputs an electric signal corresponding to the image, the image pickup device being capable of operating a normal image pickup mode and a wide dynamic range image pickup mode with a wider dynamic range than the normal image pickup mode;
an image processing section which processes the electric signal outputted from the image pickup device, the image processing section being capable of a normal image processing as a versatile image processing and a wide dynamic range image processing as an image processing specific for images picked up in the wide dynamic range image pickup mode;
an image recording section which includes an image recording media, the image recording section for recording an image signal processed by the image processing section in the image recording media;
an recording format selection section for selecting one mode from an unprocessed image recording format and a processed image recording format as a recording format in the image recording section;
an image pickup mode selection section for selecting one mode from the normal image pickup mode or the wide dynamic range image pickup mode; and
an image pickup control section which controls a process executed in the image processing section based on the image pickup mode selected by the mode selection section and the recording format selected by the recording format selection section.

2. The image pickup apparatus of claim 1, wherein the image pickup control section makes the image processing section execute the normal image processing when the image pickup mode selection section selects the normal image processing mode, and the image recording format selection section selects the processed image recording format.

3. The image pickup apparatus of claim 1, wherein the image pickup control section makes the image processing section execute the normal image processing and the wide dynamic range image processing when the image pickup mode selection section selects the wide dynamic range image pickup mode, and the recording format selection section selects the processed image recording format.

4. The image pickup apparatus of claim 1, wherein the image pickup device generates an electric signal corresponding to an amount of incident light and has a photoelectric conversion characteristic which has a linear characteristic region where the electric signal is linearly converted corresponding to the amount of incident light and a logarithmic characteristic region where the electric signal is logalithmically converted corresponding to the amount of incident light, a range of the linear region and the logarithmic region being able to be controllable to the extent where the photoelectric conversion characteristic only has the logarithmic characteristic region,
wherein the image pickup control section controls the range of the linear characteristic region and the logarithmic characteristic region, the image pickup control region controlling the range to have only the linear characteristic region when the image pickup mode selection section selects the normal image pickup mode and controlling the range to include the logarithmic characteristic region when the image pickup mode selection section selects the wide dynamic range image pickup mode.

5. The image pickup apparatus of claim 1, wherein the wide dynamic range processing is a processing of heightening contrast of an electric signal of the image picked up in the wide dynamic range image pickup mode.

6. The image pickup apparatus of claim 1, wherein the image processing section, in the processing of heightening contrast, extracts a illumination component from the electric signal outputted from the image pickup device and compresses the illumination component.

7. The image pickup apparatus of claim 1, wherein the wide dynamic range image processing is a processing of converting an electric signal of the image picked up in the wide dynamic range image pickup mode to an electric signal of an image assumed to be picked up by the normal image pickup mode.

8. The image pickup apparatus of claim 1, comprising:
a first processing path which executes the wide dynamic range image processing; and
a second processing path which does not execute the wide dynamic range image processing;
wherein the second path executes an image processing, when the image pickup mode selection section selects the normal image pickup mode.

9. The image pickup apparatus of claim 1, comprising:
a parameter setting section which sets a process parameter for the wide dynamic range image processing,
wherein the processing section executes a process in reference to the process parameter,
wherein the parameter setting section sets the process parameter so that the wide dynamic range image processing is executed when the image pickup mode selection section selects the wide dynamic range image processing, and the parameter setting section sets the parameter so that the wide dynamic range image processing is invalidated when the image pickup mode selection section selects the normal image pickup mode.

10. The image pickup apparatus of claim 1, wherein the image processing section, in the normal image processing, executes a data compression processing of compressing an electric signal of the image picked up by the image pickup device.

11. The image pickup apparatus of claim 1, wherein the image pickup control section prohibits either of the normal image processing and the wide dynamic range image processing in the image processing section when the recording format selection section selects the unprocessed image recording format.

12. The image pickup apparatus of claim 1, wherein the image recording section includes an image memory, and the image signal processed in the image processing section is stored in the image memory, and then the image signal stored in the image memory is recorded in the image recording media.

13. An image pickup apparatus, comprising:
an image pickup device which takes an image of a photographic subject and outputs an electric signal corresponding to the image, the image pickup device being capable of operating a normal image pickup mode and a wide dynamic range image pickup mode with a wider dynamic range than the normal image pickup mode;
an image processing section which processes the electric signal outputted from the image pickup device, the image processing section being capable of a normal image processing as a versatile image processing and a wide dynamic range image processing as an image processing specific for images picked up in the wide dynamic range image pickup mode;
an image recording section which includes an image recording media, the image recording section for recording an image signal processed by the image processing section in the image recording media;
an recording format selection section for selecting one mode from an unprocessed image recording format and a processed image recording format as a recording format in the image recording section;
an image pickup mode selection section for selecting one mode from the normal image pickup mode or the wide dynamic range image pickup mode; and
an image pickup control section which controls a process executed in the image processing section based on the image pickup mode selected by the mode selection section and the recording format selected by the recording format selection section,
wherein the image pickup control section makes the image processing section execute the normal image processing when the image pickup mode selection section selects the normal image processing mode, and the image recording format selection section selects the processed image recording format, and the image pickup control section makes the image processing section execute the normal image processing and the wide dynamic range image processing when the image pickup mode selection section selects the wide dynamic range image pickup mode, and the recording format selection section selects the processed image recording format.

14. The image pickup apparatus of claim 3, wherein the image pickup control section prohibits either of the normal image processing and the wide dynamic range image processing in the image processing section when the recording format selection section selects the unprocessed image recording format.
